(19) United States
(12) Patent Application Publication
(10) Pub. No.: US 2013/0011524 A1
(43) Pub. Date: Jan. 10, 2013

(54) WHITE CHOCOLATE-IMPREGNATED FOOD AND METHOD FOR PRODUCING SAME

(75) Inventors: Takeshi Hareyama, Tsurugashima-shi (JP); Mitsuharu Kurosu, Tsurugashima-shi (JP); Mitsunori Takahara, Koto-ku (JP)

(73) Assignee: MEIJI CO., LTD., Tokyo (JP)

(21) Appl. No.: 13/579,457

(22) PCT Filed: Mar. 17, 2011
(86) PCT No.: PCT/JP2011/056404

§ 371 Date: Aug. 16, 2012

(30) Foreign Application Priority Data
Mar. 31, 2010 (JP) 2010-080307

(51) Int. Cl. A23G 1/54

(52) U.S. Cl. 426/103; 426/281

(57) ABSTRACT

Provided is a white chocolate-impregnated food in which a porous food is impregnated with white chocolate material, wherein a milk solids-not-fat content in the white chocolate material is not less than 15% by weight, and a median diameter of particles in the white chocolate material is not more than 6 μm. A white chocolate-impregnated food in which a white chocolate is well impregnated into inner portion of a porous food is obtained by subjecting a white chocolate material containing not less than 15% by weight of milk solids-not-fat to a primary milling to obtain a primary white chocolate material; subjecting the primary white chocolate material to a secondary milling with a wet mill to obtain a secondary white chocolate material, a median diameter of the particles in which is not more than 6 μm; and impregnating a porous food with the secondary white chocolate material.

### TECHNICAL FIELD

The present invention relates to a white chocolate-impregnated food in which a porous food is impregnated with white chocolate, and to a process of producing the same.

### BACKGROUND ART

Foods impregnated with a liquid food are conventionally well-known. Examples of such foods include those wherein baked rice confectionery (Patent Literature 1), crouton (Patent Literature 2), a foam-containing food other than crouton (Patent Literature 3) or a freeze-dried food (Patent Literature 4), respectively, is impregnated with a liquid food.

As the method of impregnation in the production of the above-described impregnated foods, the following methods are known: (1) An impregnation method wherein crouton and chocolate are mixed and placed in a pressure reducing device, the pressure in the pressure reducing device is reduced to eliminate foams, and the pressure is returned to normal pressure, thereby impregnating with the chocolate (Patent Literature 2). (2) An impregnation method wherein a food is brought into contact with a liquid component, reducing the pressure, and then increasing the pressure, thereby impregnating the food with the liquid component (Patent Literatures 5 and 6). (3) An impregnation method wherein a food is brought into contact with a liquid having a viscosity at room temperature of 1 to 7,000 cps, and applying to centrifugal force to the food contacting the liquid, thereby impregnating the food with the liquid (Patent Literature 7).

### CITATION LIST

### Patent Literature

Patent Literature 1: JP 9-98719 A
Patent Literature 2: JP 9-308431 A
Patent Literature 3: WO 97/4207
Patent Literature 4: JP 2002-291415 A
Patent Literature 5: JP 2001-238612 A
Patent Literature 6: JP 2002-354988 A
Patent Literature 7: JP 2002-209530 A

### SUMMARY OF INVENTION

### Technical Problem

However, the present inventors discovered that when baked confectionery are tried to be impregnated with white chocolate by the above-described methods (1) to (3), the baked confectionery are impregnated only with the oil component, and coagulated white milk solids remain on the surface of the baked confectionery, so that the homogeneous material cannot be impregnated sufficiently into inner portion of the baked confectionery. This is thought to be because white chocolate material has a high milk solids-not-fat content.

An object of the present invention is to provide a white chocolate-impregnated food in which the white chocolate is sufficiently impregnated into the inner portion of the porous food without being separated into oil component and milk solids, as well as a production process thereof.

### Solution to Problem

To solve the above-described problems, the present inventors intensively studied to succeed in providing the following white chocolate-impregnated food and production process thereof:

(1) A white chocolate-impregnated food in which a porous food is impregnated with white chocolate material, wherein a milk solids-not-fat content in the white chocolate material is not less than 15% by weight, and a median diameter of particles in the white chocolate material is not more than 6 μm.
(2) The white chocolate-impregnated food according to (1), wherein an oil content in the white chocolate material is not less than 35% by weight and not more than 85% by weight.
(3) The white chocolate-impregnated food according to (1), wherein an oil content in the white chocolate material is not less than 40% by weight and not more than 75% by weight.
(4) The white chocolate-impregnated food according to any one of (1) to (3), wherein the milk solids-not-fat in the white chocolate material are derived from at least one dairy product selected from the group consisting of dry whole milk, non-fat dry milk and cheese powder.
(5) The white chocolate-impregnated food according to any one of (1) to (4), wherein the porous food is baked confectionery.
(6) The white chocolate-impregnated food according to any one of (1) to (5), wherein the white chocolate material is milled with a wet mill.
(7) The white chocolate-impregnated food according to (6), wherein the wet mill is a bead mill.
(8) The white chocolate-impregnated food according to any one of (1) to (5), wherein a particle size distribution of the particles in the white chocolate material is monodisperse.
(9) A process of producing a white chocolate-impregnated food in which a porous food is impregnated with white chocolate material, comprising the steps of: subjecting a white chocolate material containing not less than 15% by weight of milk solids-not-fat to a primary milling to obtain a primary white chocolate material; subjecting the primary white chocolate material to a secondary milling with a wet mill to obtain a secondary white chocolate material, a median diameter of the particles in which is not more than 6 μm; and impregnating a porous food with the secondary white chocolate material.
(10) The process of producing a white chocolate-impregnated food according to (9), wherein an oil content in the primary or secondary white chocolate material is not less than 35% by weight and not more than 85% by weight.
(11) The process of producing a white chocolate-impregnated food according to (9), wherein an oil content in the primary or secondary white chocolate material is not less than 40% by weight and not more than 75% by weight.
(12) The process of producing a white chocolate-impregnated food according to any one of (9) to (11), wherein the milk solids-not-fat in the primary or secondary white chocolate material are derived from at least one dairy product selected from the group consisting of dry whole milk, non-fat dry milk and cheese powder.
(13) The process of producing a white chocolate-impregnated food according to any one of (9) to (12), wherein the wet mill is a bead mill.
(14) The process of producing a white chocolate-impregnated food according to any one of (9) to (13), wherein the porous food is baked confectionery.
(15) The process of producing a white chocolate-impregnated food according to any one of (9) to (14), wherein a particle size distribution of the particles in the secondary white chocolate material is monodisperse.

### Advantageous Effects of Invention

By the present invention, a white chocolate-impregnated food in which the white chocolate having a high milk solids-not-fat content is sufficiently impregnated into the inner portion of the porous food without being separated into oil component and milk solids is obtained. Further, an impregnated food having excellent flavor and texture in which the flavor of white chocolate is not too strong is obtained.

### BRIEF DESCRIPTION OF DRAWINGS

FIG. 1 shows the particle size distributions of a primary white chocolate material 1 (open circle) and a secondary white chocolate material 1 (closed circle), respectively.

FIG. 2 shows the particle size distributions of a primary white chocolate material 3 (open circle) and a secondary white chocolate material 3 (closed circle), respectively.

### DESCRIPTION OF EMBODIMENTS

In the present invention, “porous food” may be any food as long as it has a porous space therein. Examples of the porous food include freeze-dried products of fruits, vegetables, seafoods, livestock meats, eggs and molded foods (molded mixtures of various raw materials); various puffed foods such as puffed snacks produced by deep flying a raw material, blowing hot wind to pelletized material to puff the material, or cooking and puffing a raw material by an extruder; and baked confectionery such as arare (small rice crackers), okoshi (millet-and-rice cake), karinto (small sugar-coated stick), wafers, croutons, meringues, biscuits, pies, cookies and sponge cakes, as well as breads such as white bread and French bread; doughnuts; waffles; and freeze-dried tofu and the like.

In the present invention, the term “white chocolate” is defined as a chocolate containing not less than 21% by weight of cocoa butter, not less than 14% by weight of milk solids and not more than 3% by weight of water. It should be noted, however, the term “cocoa butter” herein also includes cocoa butter equivalents.

In the present invention, the term “median diameter” means the particle size at which the integrated value of the particle size in the particle size distribution is 50%, which particle size distribution is measured with a laser diffraction based particle size analyzer SALD-2200 (SHIMADZU CORPORATION). The term “mode diameter” herein means the particle size at which the relative amount of particles is the largest.

In the present invention, the term “viscosity” means the viscosity measured with a Brookfield viscometer at 40° C. using a rotor No. 6 at a rotating speed of 4 rpm.

The viscosity of a primary white chocolate material may be, for example, 2,000 cps to 4,500 cps, and the viscosity of a secondary white chocolate material may be, for example, 5,000 cps to 15,000 cps.

In the present invention, the white chocolate material can be prepared by a conventional method, for example, the following method. As raw materials of the white chocolate, for example, a dairy product, sugar, cocoa butter, an emulsifier and the like are mixed. Examples of the dairy product include dry whole milk, non-fat dry milk, cheese powder and the like. Milk solids-not-fat herein mean milk solids excluding fats. The content of the milk solids-not-fat is preferably not less than 15% by weight. Examples of the sugar herein include monosaccharides and disaccharides such as sucrose (table sugar and powdered sugar), glucose, fructose, maltose, invert sugar and lactose. As the sugar, other than those described above, high-potency sweeteners such as sucralose, stevia, aspartate, acesulfame K and saccharin; sugar alcohols such as xylitol, maltitol, erythritol, sorbitol, lactitol, palatinose and mannitol; and reduced sugar syrup may also be added. Further, a cocoa butter equivalent as well as mixtures of cocoa butter and a cocoa butter equivalent may also be used instead of cocoa butter. Examples of the cocoa butter equivalents include tempering oils and non-tempering oils, derived from animals or plants. Examples of the emulsifiers include lecithin, glycerin fatty acid esters, sucrose fatty acid esters and the like. In addition to the above-described components, a flavor and/or a coloring agent may be added to the white chocolate material.

An oil content of the white chocolate material preferably is not less than 35% by weight and not more than 85% by weight, more preferably not less than 40% by weight and not more than 75% by weight, based on the whole white chocolate material. If the oil content is less than 35% by weight, the viscosity is high, so that impregnation may be difficult, which is not suitable. If the oil content is more than 85% by weight, the milk solids-not-fat content is less than 15% by weight, so that impregnation with the white chocolate material can be attained without separation into oil and milk solids even by a known method, and so there is no problem which is to be solved by the present invention. Although the upper limit of the milk solids-not-fat content in the white chocolate material is not restricted, the milk solids-not-fat content is usually and preferably not more than 65% by weight in order to keep the white chocolate material in liquid form.

The mixed material is then finely milled with a refiner or an attritor type ball mill (boll diameter: 5 to 10 mm). In the present invention, this milling is called primary milling, and the resulting white chocolate material is called “primary white chocolate material”. The median diameter of the particles in the primary white chocolate material is, for example, 7 μm to 20 μm.

The primary white chocolate material is then subjected to a secondary milling with a wet mill to obtain a material having a median diameter of not more than 6 μm. In the present invention, the white chocolate material obtained by the secondary milling is called “secondary white chocolate material”. As the wet mill, a bead mill, for example, may be employed. In the bead mill, the primary white chocolate material in the form of liquid is transferred by a pump to a chamber called milling chamber. The milling chamber contains the beads in an amount of about 85% of the total space of the milling chamber. The diameter of the bead is selected depending on the material to be milled. The diameter of the bead used in the present invention may be, for example, 0.1 mm to 3.0 mm, preferably 0.8 mm to 2.0 mm. If the diameter of the bead is less than 0.1 mm, it may be difficult to separate the beads and the white chocolate material after the milling. If the diameter of the bead is more than 3.0 mm, the beads are too heavy, so that the milling efficiency of the material is decreased.

By rotating the rotating shaft in the center of the milling chamber, the beads packed in the milling chamber move. The primary white chocolate material transferred to the milling chamber collides with the beads, so that the particles are further broken to smaller particles and dispersed. The milled product may be further continuously made to pass through the milling chamber one or more additional times after the white chocolate material is made to pass through the milling chamber for the first time. The rotating speed of the rotating shaft may preferably be, for example, 1,000 to 2,800 rpm.

Examples of the material constituting the beads include glass, quartz, titania, silicon nitride, alumina, ceramics (such as zirconia and zirconia-reinforced alumina), steel and stainless steel. As the bead mill, OB MILL (trade name) produced by TURBO KOGYO CO., LTD. and MIGHTY MILL (trade name) produced by INOUE MFG., INC. may be used, for example.

The milled product obtained by the secondary milling by the wet mill is characterized in that the width of the particle distribution is narrow, that is, that the particle distribution is monodisperse. As will be shown in the Examples below, the particle distribution of the primary white chocolate material is polydisperse, and the difference between the mode diameter and median diameter is large. In contrast, the particle size distribution of the secondary white chocolate material after the secondary milling is monodisperse, and the difference between the mode diameter and median diameter becomes smaller. Not only because the particle size becomes smaller, but because the particles becomes hardly coagulates, the secondary white chocolate material can be more easily impregnated into the inner portion of the porous food.

The primary or secondary white chocolate material may be subjected to conching with a conche.

In the present invention, when the white chocolate material in melted state is brought into contact with the porous food, if desired, tempering may be performed at an appropriate temperature, for example at 30° C. to 35° C. In the tempering, a seeding agent which is a high melting oil such as BOB (1,3-dibehenoyl-2-oleoyl-sn-glycerol) may be added. An example of commercially available seeding agents is BOBSTAR (trade name, produced by FUJI OIL CO., LTD., a mixture of 50% by weight of BOB powder and 50% by weight of powdered sugar).

In the present invention, methods of impregnating the porous food with the secondary white chocolate material to produce the impregnated food include, when largely classified, the following two methods. That is, (1) impregnation method utilizing difference in pressure, and (2) impregnation method utilizing centrifugal force.

Impregnation Method Utilizing Difference in Pressure

Examples of the method of impregnation utilizing the difference in pressure, which may be employed in the present invention, include (A) a method wherein the porous food is brought into contact with, or immersed into the above-described white chocolate material in melted state under reduced pressure, and then the pressure is returned to normal pressure; (B) a method wherein the porous food is subjected to reduced pressure and then the food is brought into contact with or immersed into the white chocolate material; (C) a method wherein the porous food is brought into contact with, or immersed into the above-described white chocolate material in melted state under reduced pressure, and then the pressure is increased to a pressure higher than normal pressure to be impregnated with the white chocolate material; and (D) a method wherein after preparing a white chocolate-impregnated porous food by the above-described method (A), the cycle of reducing the pressure and then returning the pressure to normal pressure in the sealed system is repeated without contacting with or immersing into the white chocolate material. In the above-described methods, in cases where the pressure is reduced, the pressure may be reduced by a vacuum pump and the lowest pressure reached in the sealed system may be, for example, 5 kPa to 70 kPa. In cases where the pressure is increased to a pressure higher than normal pressure, after air-purging the vacuum-pressurizing impregnation tank, compressed air or nitrogen gas may be introduced therein to attain a maximum pressure of, for example, 200 kPa to 1000 kPa. After the impregnation, the excess white chocolate material may be removed from the surface of the food using an air blower or the like.

Impregnation Method Utilizing Centrifugal Force

The white chocolate material liquefied under heat is applied to the surface of the porous food or the porous food is immersed in the liquid white chocolate material. Then the porous food contacting the white chocolate material is placed in a centrifuge and centrifugation is performed usually while tempering the food at 30° C. to 35° C. This method can be carried out according to the method disclosed in JP 2002-209530 A. The white chocolate material and the porous food may be contacted from the beginning, or may be contacted after starting the centrifugation. The centrifugation may be carried out under cooling depending on the type of the food. The centrifugal force is not restricted, and may be usually the one attained by a rotating speed of 100 to 4,000 rpm with a normal centrifuge. The centrifugation time may be selected depending on the properties of the food to be impregnated and the white chocolate material, degree of impregnation, and degree of coating.

After impregnating the porous food with the secondary white chocolate material by the above-described method, the impregnated secondary white chocolate material is solidified under cooling at a temperature of 15° C. or lower to obtain a white chocolate-impregnated food.

### EXAMPLES

The present invention will now be described in more detail by way of examples. However, the present invention is not restricted to these examples.

### Production Example 1

### Production of Baked Confectionery

Chicken eggs in an amount of 140 parts by weight, 100 parts by weight of table sugar, 25 parts by weight of an emulsifier and 85 parts by weight of water were well mixed with stirring, and then 150 parts by weight of cake flour was added thereto, followed by mixing the resulting mixture to obtain a liquid seed dough. The obtained dough was flowed into a metal mold, and baked in an oven at 180° C. for 30 minutes, followed by drying at 100° C. for 30 minutes to obtain a baked confectionery sizing 55 mm×15 mm×15 mm.

### Example 1

### Preparation of Primary White Chocolate Material 1

Dry whole milk, powdered sugar, cocoa butter, lecithin and glycerin fatty acid ester were mixed at the ratio shown in Table 1 by a conventional method. The mixture was milled with a refiner to obtain a primary white chocolate material 1 having a milk solids-not-fat content of 18% by weight and an oil content of 50% by weight. A median diameter and a viscosity of the particles in the material is 8.1 μm and 3,750 cps, respectively.

TABLE 1

| | Content |
|---|---|
| Raw material | (parts by weight) |
| Dry whole milk | 25.5 |
| Powder sugar | 31.0 |
| Cocoa butter | 42.0 |
| Lecithin | 0.5 |
| Glycerin fatty acid ester | 1.0 |

Preparation of Secondary White Chocolate Material 1

The primary white chocolate material 1 was transferred to a bead mill (OB MILL, trade name, produced by TURBO KOGYO CO., LTD., bead diameter: 0.5 mm) by a pump, and made to pass through a milling chamber at a product temperature of 62.2° C. to 63.2° C. at a rotating speed of 1000 rpm. This operation was continuously repeated 3 times to obtain a secondary white chocolate material 1. A median diameter and a viscosity of the particles in the material is 3.1 μm and 10,000 cps, respectively.

Production of Impregnated Food 1

The secondary white chocolate material 1 (100 parts by weight) was tempered at 30° C. to 35° C. and mixed with 3 parts by weight of BOBSTAR (trade name, produced by FUJI OIL CO., LTD., a mixture of 50% by weight of BOB powder and 50% by weight of powdered sugar). While keeping the product temperature at 30° C. to 35° C., the baked confectionery produced in Production Example 1 was embedded in the BOB-containing secondary white chocolate material 1. After placing the resulting material in a sealed container, the pressure was reduced to 10.7 kPa and immediately thereafter, the pressure was returned to normal pressure. The baked confectionery were then taken out of the white chocolate material and the white chocolate material attached to the surface of the baked confectionery was removed with a blower (noise-free blower and exhauster, produced by NISHIMURA DENKI CO., LTD). The product was cooled at 13° C. to solidify the white chocolate material to obtain an impregnated food 1 in which the white chocolate was impregnated deeply into the inner portion of the baked confectionery. The impregnated food 1 was baked confectionery having excellent flavor and texture in which the flavor of white chocolate was not too strong.

### Example 2

### Preparation of Primary White Chocolate Material 2

Non-fat dry milk, powder sugar, cocoa butter, lecithin and glycerin fatty acid ester were mixed at the ratio shown in Table 2 by a conventional method. The mixture was milled with a refiner to obtain a primary white chocolate material 2 having a milk solids-not-fat content of 15% by weight and an oil content of 54% by weight. A median diameter and viscosity of the particles in the material is 9.2 μm and 3,900 cps, respectively.

TABLE 2

| | Content |
|---|---|
| Raw material | (parts by weight) |
| Non-fat dry milk | 16.0 |
| Powder sugar | 30.0 |
| Cocoa butter | 53.5 |
| Lecithin | 0.4 |
| Glycerin fatty acid ester | 0.1 |

Preparation of Secondary White Chocolate Material 2

The primary white chocolate material 2 was subjected to secondary milling with a bead mill in the same manner as in Example 1 to obtain a secondary white chocolate material 2. A median diameter and viscosity of the particles in the material is 4.2 μm and 12,000 cps, respectively.

Production of Impregnated Food 2

The secondary white chocolate material 2 in place of the secondary white chocolate material 1 was impregnated into the baked confectionery produced in Production Example 1 in the same manner as in Example 1 to obtain an impregnated food 2 in which the white chocolate was impregnated deeply into inner portion of the baked confectionery.

### Example 3

### Preparation of Primary White Chocolate Material 3

Cheese powder, cocoa butter and lecithin were mixed at the ratio shown in Table 3 by a conventional method. The mixture was subjected to a milling with an attritor type ball mill (produce by MITSUI MIIKE MACHINERY CO., LTD., ball diameter: 9.5 mm) for 40 minutes to obtain a primary white chocolate material 3 having a milk solids-not-fat content of 25% by weight and an oil content of 74% by weight. A median diameter and viscosity of the particles in the material is 15.5 μm and 2,500 cps, respectively.

TABLE 3

| | Content |
|---|---|
| Raw material | (parts by weight) |
| Cheese powder | 47.0 |
| Cocoa butter | 52.7 |
| Lecithin | 0.3 |

Preparation of Secondary White Chocolate Material 3

The primary white chocolate material 3 was transferred to a bead mill (OB MILL, trade name, produced by TURBO KOGYO CO., LTD., bead diameter: 0.5 mm) by a pump, and made to pass once through a milling chamber at a product temperature of 44.4 to 49.2° C. at a rotating speed of 1,500 rpm to obtain a secondary white chocolate material 3. A median diameter and viscosity of the particles in the material is 5.2 μm and 5,000 cps, respectively.

Production of Impregnated Food 3

The secondary white chocolate material 3 in place of the secondary white chocolate material 1 was impregnated into the baked confectionery produced in Production Example 1 in the same manner as in Example 1 to obtain an impregnated food 3 in which the white chocolate material was impregnated deeply into inner portion of the baked confectionery without being separated into oil component and solid component.

### Comparative Example 1

### Production of Comparative Impregnated Food 1

The primary white chocolate material 1 (100 parts by weight) was tempered at 30° C. to 35° C. and mixed with 3 parts by weight of BOBSTAR (trade name, produced by FUJI OIL CO., LTD., a mixture of 50% by weight of BOB powder and 50% by weight of powdered sugar). While keeping the temperature at 30° C. to 35° C., the baked confectionery produced in Production Example 1 was embedded in the BOB-containing primary white chocolate material 1. After placing the resulting material in a sealed container, the pressure was reduced to 10.7 kPa and immediately thereafter, the pressure was returned to normal pressure. A comparative impregnated food 1 wherein white solids are coagulated on the surface of the baked confectionery and only oil component was impregnated into the baked confectionery was obtained. Thus, an impregnated food into which white chocolate was impregnated was not obtained.

### Comparative Example 2

### Production of Comparative Impregnated Food 2

Using the white chocolate material 2 obtained in Example 2, the impregnation treatment as in Comparative Example 1 was carried out. As a result, a comparative impregnated food 2 wherein white solids are coagulated on the surface of the baked confectionery and only oil component was impregnated into the baked confectionery was obtained. Thus, an impregnated food into which white chocolate was impregnated was not obtained.

### Comparative Example 3

### Production of Comparative Impregnated Food 3

Using the white chocolate material 3 obtained in Example 3, the impregnation treatment as in Comparative Example 1 was carried out. As a result, a comparative impregnated food 3 wherein white solids are coagulated on the surface of the baked confectionery and only oil component was impregnated into the baked confectionery was obtained. Thus, an impregnated food into which white chocolate was impregnated was not obtained.

### Test Example 1

The following test was carried out in order to investigate the influence of the change in the oil component on the impregnation.

Preparation of Primary and Secondary White Chocolate Materials, which Have an Oil Content of 40% by Weight

Dry whole milk, powder sugar, cocoa butter and lecithin were mixed at the ratio shown in Table 4. The mixture was milled with a refiner to prepare a primary white chocolate material 4 (hereinafter referred to as “primary material 4”) having a milk solids-not-fat content of 22% by weight and an oil content of 40% by weight. A median diameter of the particles in this material was 10.3 μm.

The primary material 4 was transferred to a bead mill (OB MILL, trade name, produced by TURBO KOGYO CO., LTD., bead diameter: 2.0 mm) by a pump, and made to pass once through a milling chamber at a product temperature of 60 to 62° C. at a rotating speed of 1,000 rpm to obtain a secondary white chocolate material 4 (hereinafter referred to as “secondary material 4”). A median diameter of particles in the material is 4.6 μm.

TABLE 4

| | Content |
|---|---|
| Raw material | (parts by weight) |
| Dry whole milk | 30.5 |
| Powder sugar | 37.0 |
| Cocoa butter | 32.0 |
| Lecithin | 0.5 |

### Preparation of Primary White Chocolate Material Having an Oil Content of not Less than 40% by Weight

To the primary material 4 (100 parts by weight) having an oil content of 40% by weight, obtained by the treatment with a refiner alone, cocoa butter in an amount of 8, 18, 32, 48, 70 or 99 parts by weight was added to obtain a primary white chocolate material having an oil content of 45%, 50%, 55%, 60%, 65% or 70% by weight. The obtained primary white chocolate materials are designated primary materials 5, 6, 7, 8, 9 and 10, respectively. A median diameter of the particles in all of these materials is 10.3 μm.

Preparation of Secondary White Chocolate Material Having an Oil Content of not Less than 40% by Weight

To the secondary material 4 (100 parts by weight) having an oil content of 40% by weight, obtained by the treatment with a bead mill having beads with a diameter of 2 mm, cocoa butter in an amount of 8, 18, 32, 48, 70 or 99 parts by weight was added to obtain a secondary white chocolate material having an oil content of 45%, 50%, 55%, 60%, 65% or 70% by weight. The obtained secondary white chocolate materials are designated secondary materials 5, 6, 7, 8, 9 and 10, respectively. A median diameter of the particles in all of these materials is 4.6 μm.

Test for Investigating Influence of Change in Oil Content on Impregnation

Using the above-described primary white chocolate materials and secondary white chocolate materials, respectively, in place of the white chocolate material 1, the baked confectionery produced by Production Example 1 was impregnated as in Example 1. The results are shown in Table 5. In Table 5, “good” means that the white chocolate was deeply impregnated into the inner portion of the baked confectionery, and “not good” means that only the oil component was impregnated into the inner portion of the baked confectionery and white milk solids were coagulated on the surface of the baked confectionery, so that impregnation was not attained. As shown in Table 5, in cases where the oil content in the white chocolate material was 40% by weight to 55% by weight, the white chocolate material was not able to be impregnated unless the secondary milling with a bead mill was carried out after the treatment with a refiner. On the other hand, in cases where the oil content of the material was not less than 60% by weight, the milk solids-not-fat content was less than 15% by weight, and the white chocolate material was able to be impregnated only by the treatment with a refiner.

TABLE 5

| | Oil | Milk solids-not-fat | | |
|---|---|---|---|---|
| | content | content | Primary | Secondary |
| Material # | (% by weight) | (% by weight) | material | material |
| 4 | 40 | 21.7 | not good | good |
| 5 | 45 | 20.1 | not good | good |
| 6 | 50 | 18.4 | not good | good |
| 7 | 55 | 16.4 | not good | good |
| 8 | 60 | 14.6 | good | good |
| 9 | 65 | 12.8 | good | good |
| 10 | 70 | 10.9 | good | good |

The weight of the baked confectionery before and after impregnation with the primary material 4 or the secondary material 4 was measured to examine the weight of the white chocolate material impregnated into the baked confectionery. The weight after impregnation was measured after wiping off the white chocolate material attached to the surface of the baked confectionary with tissue paper. As a result, only 1.5 g of the primary material 4 was impregnated into the baked confectionery, while as much as 10.4 g (about 7 times) of the secondary material 4 was impregnated into the baked confectionery.

TABLE 6

| | Primary material 4 | Secondary material 4 |
|---|---|---|
| Before impregnation | 4.0 g | 4.1 g |
| After impregnation | 5.5 g | 14.5 g |
| Difference | 1.5 g | 10.4 g |

### Example 4

### Preparation of Primary White Chocolate Material 11

Dry whole milk, powder sugar, cocoa butter, lecithin and glycerin fatty acid ester were mixed at the ratio shown in Table 7 by a conventional method. The mixture was subjected to a milling with an attritor type ball mill (produced by MITSUI MIIKE MACHINERY CO., LTD., ball diameter: 9.5 mm) for 40 minutes to obtain a primary white chocolate material 11 having a milk solids-not-fat content of 18% by weight and an oil content of 50% by weight. A median diameter and viscosity of the particles in the material is 15.5 μm and 2,500 cps, respectively.

TABLE 7

| | Content |
|---|---|
| Raw material | (parts by weight) |
| Dry whole milk | 25.5 |
| Powder sugar | 31.0 |
| Cocoa butter | 42.0 |
| Lecithin | 0.5 |
| Glycerin fatty acid ester | 1.0 |

Preparation of Secondary White Chocolate Material 11

The primary white chocolate material 11 was transferred to a bead mill (OB MILL, trade name, produced by TURBO KOGYO CO., LTD., diameter of bead: 0.5 mm) by a pump, and made to pass once through a milling chamber at a product temperature of 60.5 to 62.3° C. at a rotating speed of 1,500 rpm to obtain a secondary white chocolate material 11. A median diameter and viscosity of the particles in the material is 5.2 μm and 5,000 cps, respectively.

Production of Impregnated Food 4

The secondary white chocolate material 11 in place of the secondary white chocolate material 1 was impregnated into the baked confectionery produced in Production Example 1 in the same manner as in Example 1 to obtain an impregnated food 4 in which the white chocolate was impregnated deeply into inner portion of the baked confectionery without being separated into oil component and solid component.

### Test Example 2

### Comparison of Particle Size Distributions

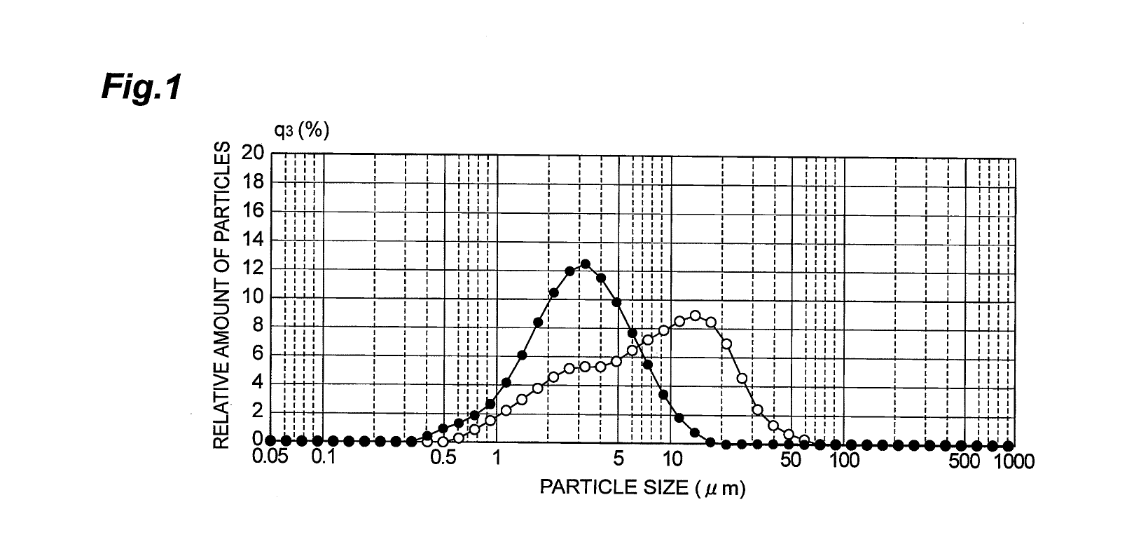

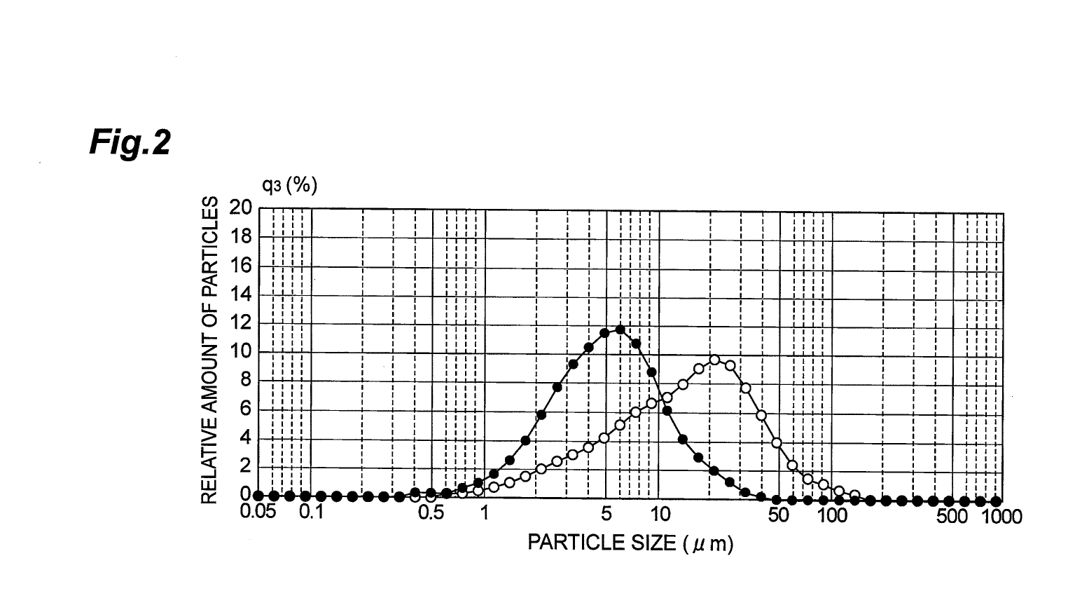

The particle size distributions of the particles in the primary white chocolate materials and secondary white chocolate materials prepared in Examples 1 and 3, respectively, were measured with a laser diffraction particle size analyzer SALD-2200 (trade name, produced by SHIMADZU CORPORATION). The particle size distributions are shown in FIGS. 1 and 2. In these figures, the relative amount of the particles in terms of % volume of the particles having the respective particle size based on the entire volume of the particles is taken along the ordinate, and the particle size in μm is taken along the abscissa. As shown in FIG. 1, in the primary white chocolate material 1, two peaks at around 3 μm and 14 μm were observed. In contrast, in the secondary white chocolate material 1 prepared by further making the primary white chocolate material 1 pass through the bead mill three times, only a sharp peak at around 3 μm was observed, that is, the particle distribution was monodisperse. The median diameter and the mode diameter of the particles in the primary white chocolate material 1 were 8.1 μm and 14.0 μm, respectively, while those of the particles in the secondary white chocolate material 1 were 3.1 μm and 3.3 μm, respectively. In FIG. 2, with the particles in the primary white chocolate material 3, a peak at 20 μm and shoulders at about 3 μm and about 9 μm were observed, while with the particles in the secondary white chocolate material 3, only one sharp peak at around 5.5 μm was observed, so that the distribution was monodisperse. The median diameter and the mode diameter of the particles in the primary white chocolate material 3 were 15.5 μm and 21.2 μm, respectively, while those of the particles in the secondary white chocolate material 3 were 5.2 μm and 6.1 μm, respectively.

1. A white chocolate-impregnated food in which a porous food is impregnated with white chocolate material, wherein a milk solids-not-fat content in the white chocolate material is not less than 15% by weight, and a median diameter of particles in the white chocolate material is not more than 6 μm.

2. The white chocolate-impregnated food according to claim 1, wherein an oil content in the white chocolate material is not less than 35% by weight and not more than 85% by weight.

3. The white chocolate-impregnated food according to claim 1, wherein an oil content in the white chocolate material is not less than 40% by weight and not more than 75% by weight.

4. The white chocolate-impregnated food according to claim 1, wherein the milk solids-not-fat in the white chocolate material are derived from at least one dairy product selected from the group consisting of dry whole milk, non-fat dry milk and cheese powder.

5. The white chocolate-impregnated food according to claim 1, wherein the porous food is baked confectionery.

6. The white chocolate-impregnated food according to claim 1, wherein the white chocolate material is milled with a wet mill.

7. The white chocolate-impregnated food according to claim 6, wherein the wet mill is a bead mill.

8. The white chocolate-impregnated food according to claim 1, wherein a particle size distribution of the particles in the white chocolate material is monodisperse.

9. A process of producing a white chocolate-impregnated food in which a porous food is impregnated with white chocolate material, comprising the steps of:
subjecting a white chocolate material containing not less than 15% by weight of milk solids-not-fat to a primary milling to obtain a primary white chocolate material;
subjecting the primary white chocolate material to a secondary milling with a wet mill to obtain a secondary white chocolate material, a median diameter of the particles in which is not more than 6 μm; and
impregnating a porous food with the secondary white chocolate material.

10. The process of producing a white chocolate-impregnated food according to claim 9, wherein an oil content in the primary or secondary white chocolate material is not less than 35% by weight and not more than 85% by weight.

11. The process of producing a white chocolate-impregnated food according to claim 9, wherein an oil content in the primary or secondary white chocolate material is not less than 40% by weight and not more than 75% by weight.

12. The process of producing a white chocolate-impregnated food according to claim 9, wherein the milk solids-not-fat in the primary or secondary white chocolate material are derived from at least one dairy product selected from the group consisting of dry whole milk, non-fat dry milk and cheese powder.

13. The process of producing a white chocolate-impregnated food according to claim 9, wherein the wet mill is a bead mill.

14. The process of producing a white chocolate-impregnated food according to claim 9, wherein the porous food is baked confectionery.

15. The process of producing a white chocolate-impregnated food according to claim 9, wherein a particle size distribution of the particles in the secondary white chocolate material is monodisperse.

16. The white chocolate-impregnated food according to claim 1, wherein an oil content in the white chocolate material is not less than 40% by weight and not more than 75% by weight, and
a particle size distribution of the particles in the white chocolate material is monodisperse.

17. The white chocolate-impregnated food according to claim 1, wherein an oil content in the white chocolate material is not less than 40% by weight and not more than 75% by weight,
the milk solids-not-fat in the white chocolate material are derived from at least one dairy product selected from the group consisting of dry whole milk, non-fat dry milk and cheese powder,
the porous food is baked confectionery,
the white chocolate material is milled with a bead mill, and
a particle size distribution of the particles in the white chocolate material is monodisperse.

18. The process of producing a white chocolate-impregnated food according to claim 9, wherein an oil content in the primary or secondary white chocolate material is not less than 40% by weight and not more than 75% by weight, and
a particle size distribution of the particles in the secondary white chocolate material is monodisperse.

19. The process of producing a white chocolate-impregnated food according to claim 9, wherein an oil content in the primary or secondary white chocolate material is not less than 40% by weight and not more than 75% by weight,
the wet mill is a bead mill, and
a particle size distribution of the particles in the secondary white chocolate material is monodisperse.

20. The process of producing a white chocolate-impregnated food according to claim 9, wherein an oil content in the primary or secondary white chocolate material is not less than 40% by weight and not more than 75% by weight,
the milk solids-not-fat in the primary or secondary white chocolate material are derived from at least one dairy product selected from the group consisting of dry whole milk, non-fat dry milk and cheese powder,
the wet mill is a bead mill,
the porous food is baked confectionery, and
a particle size distribution of the particles in the secondary white chocolate material is monodisperse.
